(19) United States
(12) Patent Application Publication
(10) Pub. No.: US 2006/0240172 A1
(43) Pub. Date: Oct. 26, 2006

(54) Preparation method for preserving cooked fish-based food products

(76) Inventor: Jean-Marc Tachet, Dolomieu (FR)

Correspondence Address: CANTOR COLBURN, LLP, 55 GRIFFIN ROAD SOUTH, BLOOMFIELD, CT, 06002, US

(21) Appl. No.: 10/544,356

(22) PCT Filed: Feb. 3, 2004
(86) PCT No.: PCT/FR04/00248

§ 371 Date: Apr. 27, 2006

(30) Foreign Application Priority Data
Feb. 3, 2003 (FR) 03/01207

(51) Int. Cl. A23L 1/325

(52) U.S. Cl. 426/643

(57) ABSTRACT

“The present invention relates to a method of preparation for preserving raw food products from fishing, the method including, in the following order, filleting the products, washing them, then pricking them, and salting the fillets obtained using a dry mixture of marinade comprising dry salt, pepper, and sugar, and at least one vaporized alcohol and/or at least one vaporized aromatic oil, and leaving the products to marinate in contact with said dry marinade, in a pickling cold room at a controlled temperature, for a period of between 5 minutes and 48 hours, and rinsing the products, and drying the products in a drying room for a period of between 1 hour and 36 hours, and finally packaging the products.”

### BACKGROUND OF THE INVENTION

The present invention relates to a method of preparation for preserving raw food products from fishing.

### DESCRIPTION OF THE PRIOR ART

In the field of the preparation for preserving food products, and in particular products from fishing, such as sea and freshwater fish, crustaceans, shellfish, and other edible species from fishing, numerous techniques are known.

In fact, it is not rare that certain products must be prepared, before packaging, for preservation for several days, up to the time when said products are prepared, for example by cooking, before being eaten.

Thus, a known technique consists in smoke-curing the fishing products, for example, fish such as salmon, trout, and halibut. Such a technique allows for a relatively long preservation time. However, it alters the initial organoleptic properties of the product thus prepared in particular: the inherent flavor of the product tends to disappear in favor of the strong flavor imparted by smoke-curing. Moreover, it is difficult to cook the products thus smoke-cured, which are generally eaten raw.

Another known technique of preparation for preserving is salting. This technique is applied routinely for sea fish such as cod. The salting technique, known for centuries, serves to obtain a long preservation time. However, this technique entails desalting before cooking.

Finally, the use of marinades, normally liquid mixtures is known, which allow the preservation of the product for a period of 8 to 15 days, sometimes 3 weeks. However, this technique has the drawback of altering the texture of the product, after prolonged contact of the flesh with the liquid.

It should be noted that most of the techniques mentioned above and currently used industrially, make use, in the composition used for preparing the products, of one or more chemical additives or preservatives—E 200 to E 297—or antioxidants—BHA (butylhydroxyanisol) (E 320) or BHT (butylhydroxytoluene) (E 321) for example—or texture agents—E 322 to E 495. Such a practice, although often necessary for the satisfactory implementation of these methods, is poorly viewed by the consumer, who prefers foods free of additives.

### SUMMARY OF THE INVENTION

The present invention therefore proposes to solve the problems discussed above, by providing a method of preparation for preserving raw products from fishing, which alters the organoleptic properties (flavor, texture) of the product or products as little as possible, using a mixture comprising no chemical preservative or additive, so that the shelf life is guaranteed for at least 14 days, a method which, furthermore, serves to obtain products ready to prepare, for example, ready to cook.

### DESCRIPTION OF THE PREFERRED EMBODIMENTS

The above object is achieved with a method of preparation for preserving raw food products from fishing, which method comprises, in the following order, the steps consisting in:
(i) filleting the products, washing them, then pricking them, and
(ii) salting the fillets obtained using a dry mixture of marinade comprising dry salt, pepper, and sugar, and at least one vaporized alcohol and/or at least one vaporized aromatic oil, and
(iii) leaving the products to marinate in contact with said dry marinade, in a pickling cold room at a controlled temperature, for a period of between 5 minutes and 48 hours, and
(iv) rinsing the products, and
(v) drying the products in a drying room for a period of between 1 hour and 36 hours, and finally
(vi) packaging the products.

“Fishing products” means any sea or freshwater fish, crustaceans, molluscs and shellfish and all aquatic or semi-aquatic species, suitable for consumption in raw or cooked form.

“Ready to prepare” means products that have been prepared by the method described above, and which, on receipt by the consumer, can be taken out of their packaging directly, and prepared to be eaten (that is, presented for eating as such, or cooked without having to be washed, rinsed, dried or desalted).

Preferably, the marinating time in the cold room is between 20 minutes and 36 hours, and the drying time is between 12 and 24 hours. The latter step is preferably carried out on a grille. These durations are determined respectively by the weight of product to be prepared.

Preferably, the marinating temperature in the cold room is between −2 and +6° C., and preferably between 0 and +2° C.

The vaporized alcohol is selected to agree with the flavor of the product to be prepared. In particular, Pernod® can be used for sea fish, such as red mullet.

The use of a vaporized alcohol serves to preserve a dry marinade, thereby preventing deterioration of the product texture due to prolonged contact with a liquid. Moreover, vaporized alcohol serves to further reduce the bacterial flora which could develop during the storage of the product, and thereby increases the shelf life. The vaporized aromatic oil can be used for the same reasons as those listed above for the alcohol.

If possible, the drying step can be carried out in the form of a smoke-cured product, depending on the type of product to be preserved.

In one possible embodiment of the invention, the products are packaged in lidded containers, under air vacuum.

According to an alternative embodiment of the present invention, the products can be packaged in lidded containers, under atmosphere modified by the addition of inert gas. The inert gas may, for instance, be nitrogen.

The present invention further provides a raw product from fishing and ready for preparation, obtained by the method described above.

At all events, the invention will be better understood from the detailed description that follows of an embodiment of a method of preparation according to the invention.

The method according to the invention consists in the preparation of raw food products from fishing, for the purpose of their preservation.

In the present example, the product is a red mullet which is preferred in the form of fillets, for preservation, using a dry marinade comprising Pernod®.

This method comprises, in the following order, the steps consisting in:
(i) filleting the red mullet, washing it, then pricking it, then
(ii) salting the fillets obtained with a dry mixture of marinade comprising dry salt, pepper, and sugar, Pernod®, then
(iii) leaving the fillets of red mullet to marinate in contact with the dry marinade, in a pickling cold room at a controlled temperature of between 0 and 2° C., for a period of between 5 minutes and 48 hours, then
(iv) rinsing the fillets, then
(v) drying the fillets on a grille in a drying room for a period of between 1 and 36 hours, and finally
(vi) packaging the fillets of red mullet in lidded containers, under controlled atmosphere with the addition of nitrogen.

The product obtained, red mullet fillets marinated with Pernod, is ready to cook. It has a minimum shelf life of 14 days.

Moreover, it has been discovered surprisingly that the method according to the invention serves to preserve the organoleptic properties of the product, that is, the inherent flavor of fish, as well as the texture of its flesh, and further to effectively stabilize the development of the total flora. Thus a microbiological analysis of the product after 14 days of preservation indicates a similar product quality to the quality during packaging, particularly without the development of bacterial agents.

This effective method of preservation is obtained without the use of chemical preservatives, or texture agents, and no undesirable exudate is produced during the preservation period.

It goes without saying that the invention is not limited to the only embodiment of this method described above by way of example, but on the contrary, encompasses all its variants. Thus in particular, it is possible to add spices or to vary the type of alcohol or oil added, to agree with the flavor and texture of the products prepared.

1. A method of preparation for preserving raw food products from fishing, which method comprises in the following order:
(i) filleting the products, washing them, then pricking them, and
(ii) salting the fillets obtained using a dry mixture of marinade comprising dry salt, pepper, and sugar, and at least one vaporized alcohol and/or at least one vaporized aromatic oil, and
(iii) leaving the products to marinate in contact with said dry marinade, in a pickling cold room at a controlled temperature, for a period of between 5 minutes and 48 hours, and
(iv) rinsing the products, and
(v) drying the products in a drying room for a period of between 1 hour and 36 hours, and finally
(vi) packaging the products.

2. The method as claimed in claim 1, wherein the products are dried on a grille in the form of a smoke-cured product.

3. The method as claimed in claim 1, wherein the products are packaged in lidded containers, under air vacuum.

4. The method as claimed in claim 1, wherein the products are packaged in lidded containers, under atmosphere modified by the addition of inert gas.

5. The method as claimed in claim 1, wherein the marinating time in the cold room is between 20 minutes and 36 hours, and the drying time is between 12 and 24 hours.

6. The method as claimed in claim 1 to 5, wherein the marinating temperature in the cold room is between −2 and +6° C.

7. A raw product from fishing, ready for preparation, which raw product it is obtained by a method as claimed in claim 1.

8. The method as claimed in claim 6, wherein the marinating temperature in the cold room is between 0 and +2° C.
